(19) United States
(12) Patent Application Publication
(10) Pub. No.: US 2013/0192467 A1
(43) Pub. Date: Aug. 1, 2013

(54) TWO STAGE DUST COLLECTION TRAILER WITH HEPA FILTRATION

(71) Applicant: Gus Lyras, Lowellville, OH (US)

(72) Inventor: Gus Lyras, Lowellville, OH (US)

(21) Appl. No.: 13/360,901

(22) Filed: Jan. 30, 2012

(51) Int. Cl. B01D 29/56

(52) U.S. Cl. 95/284; 55/385.2; 55/341.1

(57) ABSTRACT

A central mobile air collection and treatment platform to establish and maintain a negative air pressure environment in a designated structure. Multiple stage air filtration stations within a central vacuum source combine general dust filtration, collection and disposal with inline multiple particulate HEPA filtration in a high volume self-contained mobile platform configuration for adaptable multi-venue staging.

### BACKGROUND OF THE INVENTION

1. Technical Field

This invention relates to devices and processes for creating negative air environments in building structures for the collection, filtration and removal of air entrained particulate matter. Current regulations, such as Section 112 of the Clean Air Act states that particulate laden air creates health issues for workers involved in the material removable such as friable asbestos and the like. Such air contamination occurs when surfaces and structures are disturbed during renovation, disassembly, removal and rehabilitation in the construction industry. Regulations require that such particulate laden air be evacuated and that friable particulates be contained and collected during the process.

2. Description of Prior Art

Prior art devices have used a variety of different air collection, containment and filtration systems, such as room specific small mobile negative air machines with HEPA filters.

Large industrial vacuum cleaners and dust collector devices have also been developed, see for example U.S. Pat. Nos. 4,774,974, 4,820,315, 4,979,967 and 7,094,142.

In U.S. Pat. No. 4,774,974 is directed to a system for removing asbestos from structures having a remote small sealed work area connected to a collection chamber for initial particulate separation through multiple filter bags.

U.S. Pat. No. 4,820,315 discloses a vacuum loader and processor for removing asbestos comprising a separation filtration unit, a centrifuge separator, dust and portable bagger to bag and remove air entrained asbestos.

U.S. Pat. No. 4,979,967 claims a contaminant transportation apparatus having a cargo chamber, air handler to maintain vacuum pressure and a filtering system associated therewith.

Finally, in U.S. Pat. No. 7,094,142 illustrates a portable device with interchangeable cleaning modules for the removal of contaminants in an airstream.

### SUMMARY OF THE INVENTION

A mobile platform base central dust collection with HEPA filter configuration to establish a total enclosure negative vacuum particulate containment apparatus. A high volume low vac dust filtration by a dust filter bag assembly with multiple dust filter bags defines a first filter stage. A dual bank of HEPA filters arranged downstream of a vacuum containment fan provides a second and final filtration stage air cleaning of air volume calculated output equal to dust filtration required.

### DESCRIPTION OF THE DRAWINGS

FIG. 1 is a side elevational view of the collection and removal device of the invention.

FIG. 2 is a top plan view thereof.

FIG. 3 is an end view on lines 3-3 of FIG. 1.

FIG. 4 is a sectional view on lines 4-4 of FIG. 1.

### DETAILED DESCRIPTION OF THE INVENTION

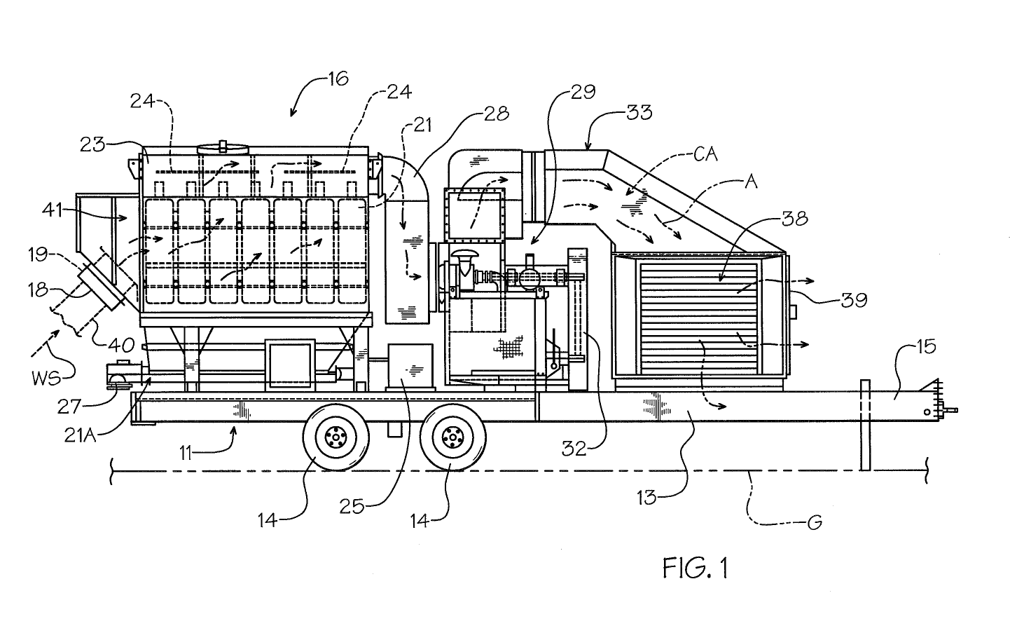

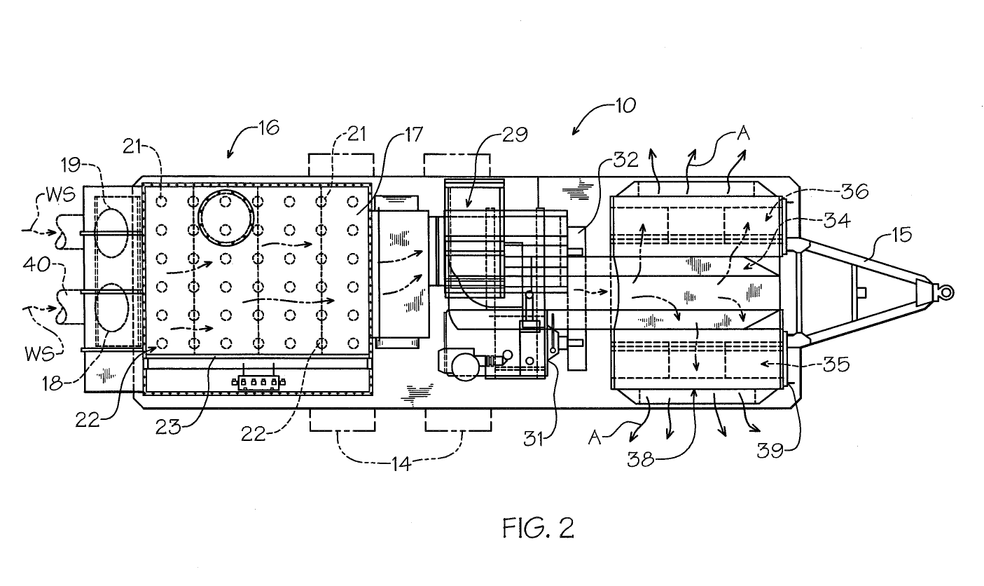

Referring now to FIGS. 1 and 2 of the drawings, a mobile vacuum dust collection filtration platform apparatus 10 of the invention can be seen having a self-contained wheeled carrier 11 with a support frame 13, dual axle wheel assemblies 14 and a hitch 15 extending from one end thereof for mobile repositioning and site transportation.

The vacuum dust collection filtration platform 10 is secured on the wheeled carrier 11 affording mobile deployment and placement at sites specific work sites (not shown) that heretofore required multiple negative air filtration application environments. The filtration platform apparatus 10 has a first stage material dust collector control assembly 16 comprised of a vacuum cartridge bag base dust filter assembly 17. Dual vacuum containment material inlets 18 and 19 are provided in communication with a plurality of dust collection filter bag cartridges 21 within the dust filter assembly 17. The dust collection filter bag cartridges 21 are arranged in aligned spaced sequential rows 22 defining maximum dust filtration exposed surface within a filter mounting and separation containment frame and enclosure 23.

Bag cartridge access panels 20 are provided for removal and service of the filter bag cartridges 21 and lower chamber clean out access assembly generally indicated at 21A as will be well known to those skilled in the art in accordance with such filtration applications in the industry. A compressed air filter purge nozzle assembly 24, illustrated graphically, is positioned above the multiple dust collection filter bag cartridges 21 and is supplied air under pressure by an onboard air compressor generally indicated at 25. The air filter purge nozzle assembly 24 allows for select “purging” of the respective filter bag cartridge assemblies, decreasing replacement requirements during operation parameters and assures maximum airflow therethrough. The “purged” dust, as noted, is collected in the clean-out assembly 21 A having a transfer auger assembly 26 and outlet valve 27 interengaged in a collective compressive manner of particulate dissemination.

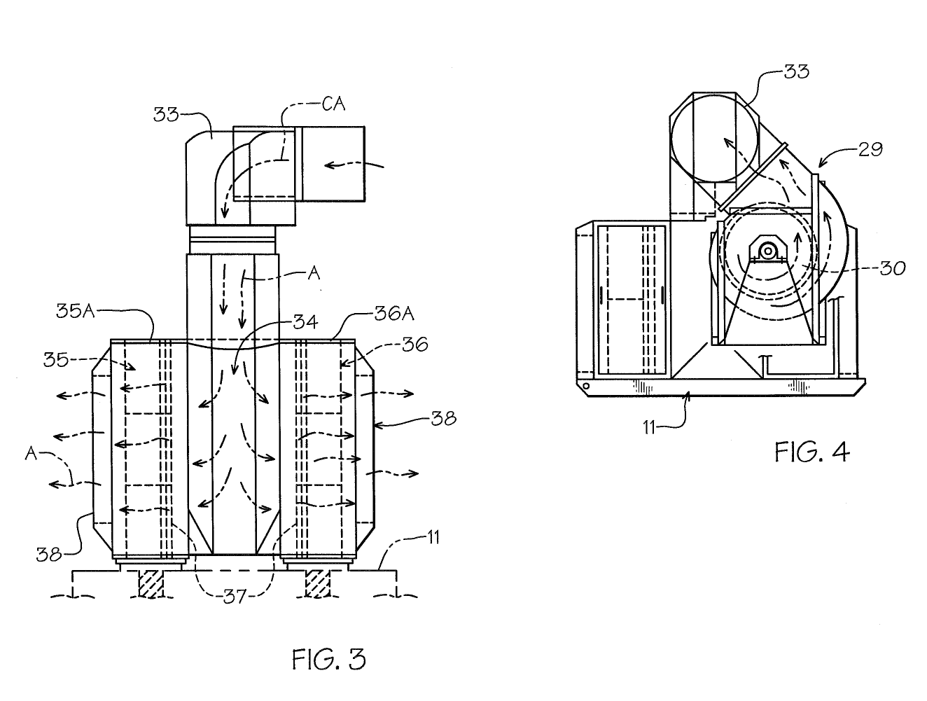

First stage dust filter 16 accordingly supplies clean air indicating at CA that exits the filter assembly 17 via a transfer collection chamber duct 28 having a high vac blower fan assembly 29 in communication therewith which supplies vacuum circulation through the multiple vacuum dust collection platform 10 of the invention. The blower fan assembly 29 has a blower fan 30 with a power drive source 31 interconnected by a drive belt and housing assembly 32 as best seen in FIGS. 1 and 4 of the drawings. The blower fan 30 draws the first stage filtered air CA up and into an air flow distribution manifold duct 33 having directional baffles 34 therewithin to divide and direct equally the air supply streams to respective spaced parallel effacing fine particulate (HEPA) filter banks 35 and 36, best seen in FIGS. 2 and 3 of the drawings. Each of the HEPA filter banks 34 and 35 arc within a containment and filter access housing 35A and 36A in which multiple HERA filter cartridges 37 are positioned.

Air flow directional arrows A illustrate air intake, filter flow patterns and exit through the hereinbefore described multiple stage negative air filtration platform apparatus 10 of the invention.

The filtered access and containment HEPA filter housings 35A and 36A have clean air exhaust outlets at 38 and multiple filter access service doors 39 affording HEPA filtration removable access and replacement based on calculated and operation air flow pressure parameters within the filter housings in accordance with standard HEPA filter applications.

In operation, the mobile vacuum dust collector filtration platform apparatus 10 is positioned at a work site indicated by broken lines arrow brackets WS to provide a central negative air vacuum dust collection and particulate filtration thereto. Establishment of such negative air environments therewithin are well known and understood within the art and as such further description and explanation is not deemed necessary.

Negative air vacuum transfer lines shown in broken lines at 40 extend from the work site WS structure establishing a negative air exhaust environment in which fresh make-up air is drawn through the work venue to maintain a negative vacuum environment via filtered exhaust air requirements applications.

The flexible transfer lines 40 extend to and are in communication with the hereinbefore described negative air vacuum contaminant material inlets 18 and 19. Contaminated particulate air stream 41 is established into the first stage dust collector assembly 16 by the disclosed and described central high vac blower fan assembly 29. The second and final filter stage designated by multiple HERA filter banks 35 and 36 as hereinbefore described assure safe exhaust air discharge at 38 into the environment. It will thus be seen that a new and novel mobile self-contained negative air particulate collection and removal device in a platform venue have been illustrated and described and it will be apparent to those skilled in the art that various changes and modifications may be made thereto without departing from the spirit of the invention. Therefore I claim:

1. A mobile apparatus for establishing central negative air collection and treatment of air entrained contaminants comprising,
a self-contained mobile trailer assembly,
a negative air collection and filtration apparatus on said trailer assembly,
said negative air collection and filtration apparatus comprises,
a first dust collection filter assembly and a secondary high efficiency air particulate air filtration filter configuration,
a central vacuum circulation source in communication with said first and second dust and air filters, collection and transportation conduits in communication with said first dust collection filter and a remote established negative air work environment.

2. The mobile apparatus for collection and treatment of contaminated air set forth in claim 1 wherein said first dust collector filter comprises,
a multiple dust bag cartridge filter assembly therewithin.

3. The mobile apparatus for collection and treatment of contaminated air set forth in claim 1 wherein said secondary high efficiency particulate air filter comprises,
an airflow distribution duct, directional baffles in communication with said duct and multiple banks of HEPA air filters.

4. The mobile apparatus for collection and treatment of contaminated air set forth in claim 1 wherein said vacuum circulation source comprises,
a blower fan downstream of said first dust collector filter and upstream of said second high efficiency particulate air filter configuration.

5. The apparatus for collection and treatment of contaminated air set forth in claim 3 wherein said multiple banks of HEPA air filters comprises,
spaced parallel effacing banks of individual HEPA filtration units within an access containment and venting housing.

6. A process for establishing a central negative air collection and treatment of entrained contaminants in a vacuum airstream comprises the steps of,
a. establishing a central negative air environment within a containment structure,
b. transferring a contaminated negative airstream to a mobile self-contained filtration vacuum apparatus platform,
c. separating airborne contaminants within said contaminated negative airstream by a first multiple dust bag cartridge filter assembly,
d. transferring filtered air from said first multiple dust bag cartridge filter assembly to a high efficiency particulate air filter assembly on said platform,
e. separating remaining airborne contaminants within an airstream from said first dust multiple bag cartridge filter assembly by said high efficiency particulate air filter assembly downstream therefrom.

7. The process set forth in claim 6 wherein said step of establishing a negative air environment within a structure comprises,
a mobile central negative air collection and filtration platform having a vacuum blower therewithin.

8. The process set forth in claim 6 wherein said transferred filtered air from said dust bag collector filter to a high efficiency particulate air filter assembly comprises,
an airflow distribution manifold duct, directional baffles in an entrained airstream defined vacuum flow air filter.
